(19) United States
(12) Patent Application Publication
(10) Pub. No.: US 2008/0163076 A1
(43) Pub. Date: Jul. 3, 2008

(54) REPLACING WEB BROWSER IMAGES WITH VIEW FINDER OR GALLERY PICTURES

(75) Inventors: Erika Reponen, Tampere (FI); Virpi Roto, Espoo (FI)

Correspondence Address: PERMAN & GREEN, 425 POST ROAD, FAIRFIELD, CT, 06824, US

(73) Assignee: Nokia Corporation, Espoo (FI)

(21) Appl. No.: 11/618,045

(22) Filed: Dec. 29, 2006

(51) Int. Cl. G06F 3/00

(52) U.S. Cl. 715/760

(57) ABSTRACT

A method including downloading a document for presentation on a device and replacing at least one image in at least one image box of the document with at least one different image from the device.

### BACKGROUND

1. Field

The disclosed embodiments relate to user interfaces and, more particularly, displaying images in a document.

2. Brief Description of Related Developments

Most web pages are designed to be viewed on, for example, land based equipment such as personal computers or on television monitors that are connected to the internet or world wide web via a land line. In conventional web browsers, as web pages are downloaded images such as pictures, word art and the like are downloaded as a content of the web page. When viewing web pages via a landline a user typically pays a flat monthly rate for the internet service. In addition, internet speeds through a land based connection are fast enough so that a user does not have to be concerned with the download time of the web page contents including the images contained in the web page content.

When a web page is viewed on a handheld or mobile device such as for example, a mobile phone, personal digital assistant (PDA) and the like that is connected to the internet via a wireless connection, download time and fees for internet connection may become a factor. To adapt the web pages to the handheld or mobile devices, the devices may have mobile web browser with a budget mode for viewing web pages. In the budget mode web pages are viewed without images to save money and downloading time. In the budget mode the images are removed from the web pages and replaced with an image box to maintain the layout of the web page. A default image provided by the web browser such as an “X” is shown in the image box. Web pages having the default image in the image box look boring and are unappealing to the user. These image boxes also create empty space within the web page that could be used.

It would be advantageous to present a custom or personalized image in the image boxes of a web page while saving time, money and device power.

### SUMMARY

In one embodiment, an apparatus is provided. The apparatus includes a display and a processor connected to the display, wherein the processor is configured to replace at least one image in at least one image box of a document presented on the display with at least one different image from the apparatus.

In one embodiment, a method is provided. The method includes downloading a document for presentation on a device and replacing at least one image in at least one image box of the document with at least one different image from the device.

In one embodiment a computer program product is provided. The computer program product includes a computer useable medium having computer readable code means embodied therein for causing a computer replace at least one image in at least one image box of a document with at least one different image. The computer readable code means in the computer program product includes computer readable program code means for causing a computer to download the document for presentation on the device and computer readable program code means for causing a computer to replace at least one image in at least one image box of the document with at least one different image from the device.

### BRIEF DESCRIPTION OF THE DRAWINGS

The foregoing aspects and other features of the disclosed embodiments are explained in the following description, taken in connection with the accompanying drawings, wherein:

FIGS. 1A-D illustrate screen shots incorporating features of an embodiment;

FIGS. 2A-B illustrate screen shots incorporating features of an embodiment;

FIGS. 3-6 illustrate screen shots in accordance with an embodiment;

FIG. 7 shows a flow diagram in accordance with an embodiment;

FIG. 8 illustrates a mobile terminal in accordance with an embodiment;

FIG. 9 illustrates a mobile terminal in accordance with an embodiment;

FIG. 10 is a block diagram illustrating the general architecture of an exemplary devices in which aspects of the disclosed embodiments may be employed;

FIG. 11 is a schematic illustration of a cellular telecommunications system, as an example, of an environment in which a communications device incorporating features of an embodiment may be applied; and

FIG. 12 illustrates a block diagram of one embodiment of a typical apparatus incorporating features that may be used to practice aspects of the invention.

### DETAILED DESCRIPTION OF THE EXEMPLARY EMBODIMENT(s)

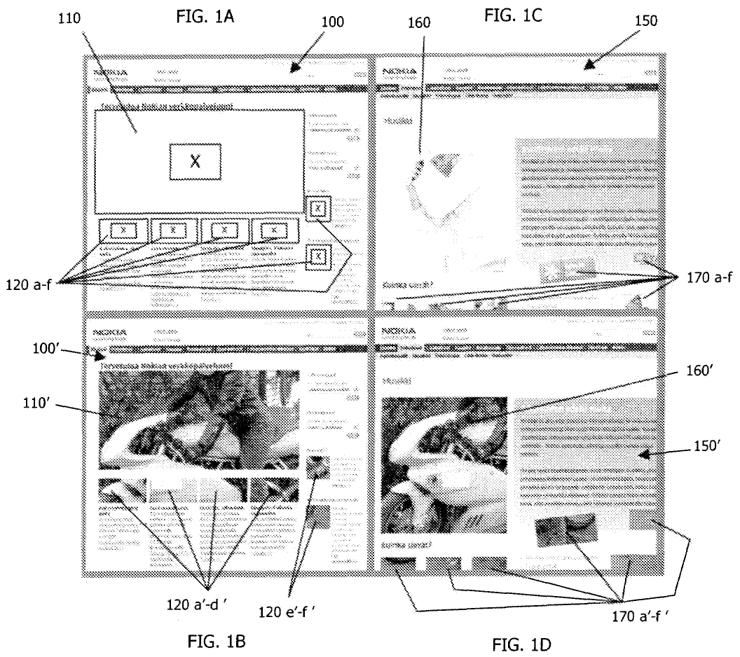

FIGS. 1A-1D illustrate screen shots incorporating features of an embodiment. Although the embodiments disclosed herein will be described with reference to the embodiments shown in the drawings, it should be understood that the embodiments disclosed can be embodied in many alternate forms of embodiments. In addition, any suitable size, shape or type of elements or materials could be used.

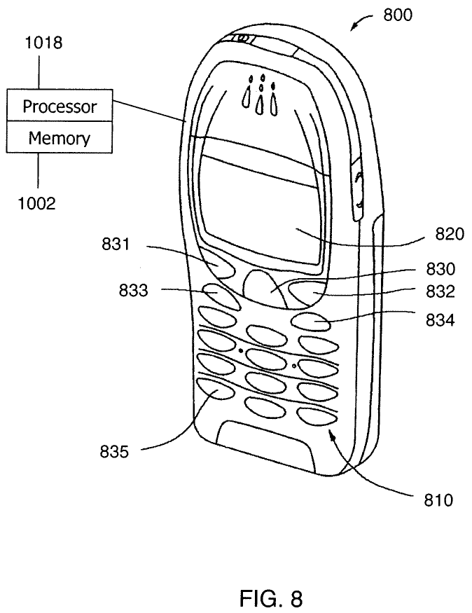

In FIG. 1A, an exemplary document in accordance with an embodiment is shown. The document may be any suitable document having images therein. The document may be displayed on the display of any suitable device, such as device 800 shown in FIG. 8. Although the embodiments described herein will be described with reference to the mobile communications device 800 for exemplary purposes only, it should be understood that the embodiments could be applied equally to any suitable device incorporating, for example, a display, processor, memory and supporting software or hardware for implementing the disclosed embodiments.

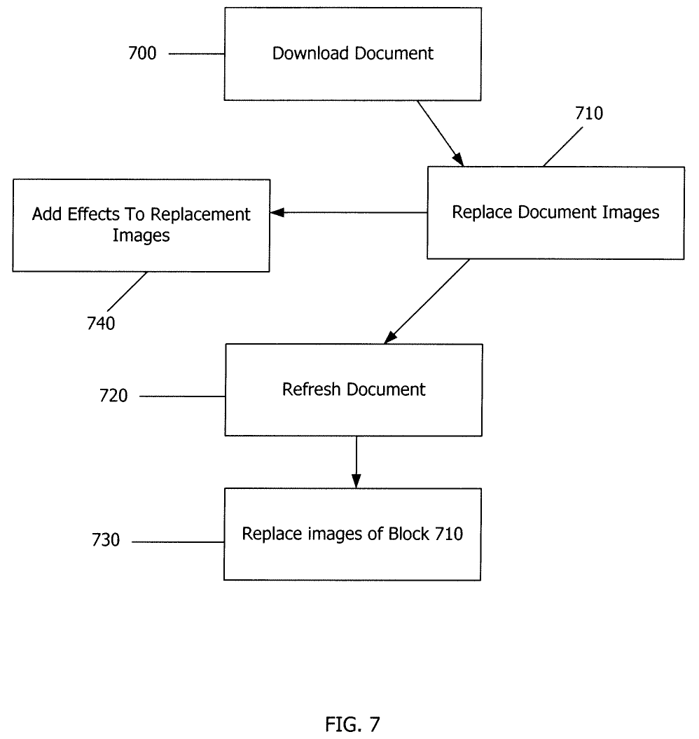

FIG. 1A illustrates a document 100 that may be downloaded into, for example, any suitable device (FIG. 7, Block 700). The document 100 may include as part of its content text and images such as images 110 and 120a-f. To save, for example, download time the images 110, 120a-f within the document may not be downloaded but may instead be presented as image boxes with a browser supplied default image such as, for example an “X” presented inside the image box as shown in FIG. 1A. This may be referred to as viewing the document in a budget mode.

In accordance with the disclosed embodiments, the image box representations of the images 110, 120a-f or the downloaded document images may be replaced with any suitable image stored in, acquired by or generated by the device 800. The image boxes may be replaced with, for example, a camera view finder image, a background or wallpaper image, a photograph, a two-dimensional or three-dimensional graphic, an animated image, a video, some visualization generated by software code of the device or any combination thereof (FIG. 7, Block 710). This list of replacement images is exemplary in nature and is a non-exhaustive list. In alternate embodiments, any suitable image may be used to replace the image boxes of document 100. In other alternate embodiments the device 800 may download one or more images from any suitable source, such as for example, another mobile device, the internet, a personal computer and the like, that may replace the image boxes of the document 100.

Referring to FIG. 1B, a web page 100′ is shown in accordance with an embodiment. Although the disclosed embodiments will be described with respect to a web page it is noted that the disclosed embodiments apply equally to any suitable document (e.g. word processing documents, spreadsheets, etc.) having images as part of the document. Web page 100′ may be substantially similar to document 100 as far as its layout is concerned. The image boxes 110′ and 120a′-120f′ are substantially similar to image boxes 110 and 120a-120f. However, rather than displaying the default image (i.e. the image box containing the “X”) a user image is placed in the image boxes 110′ and 120a′-120f′. In the example shown in FIG. 1B a camera view finder image is shown. The image boxes 110′ and 120a′-120f′ may provide a user with “windows” for viewing an image that is “behind” the web page. In this example the view finder of the device (such as that used with a camera function of the device) may acquire a live image such as, for example, a person on a motorcycle. As can be seen in FIG. 1B, the image boxes 110′, 120a′-120f′ may act as “windows” that allow the user to look through the image boxes so the user can see the view finder image of the device. The image boxes can be thought of as holes or cutouts cut in the web page for viewing a portion of the view finder image that is behind a respective one of the cutouts (it is noted that the view finder image in this example would be displayed over the entire display of the device, hence the “windows” allow only a portion of the view finder image behind the “window” to be viewed by the user). The user can see different portions of the view finder image as the user scrolls the web page up and down and/or left and right. In alternate embodiments, the portions of view finder images presented through the image boxes may not change as the user scrolls the web page. In other embodiments, as the user moves the device so the view finder is pointed in different directions the portions of the view finder image behind the image boxes 110′, 120a′-120f′ change as the device is moved around. This may give the user the feeling that the user is able to look through the device via the image boxes (“windows”) as the user is viewing the web page.

FIG. 1C is another web page 150 that may be downloaded into the device. As can be seen in FIG. 1C the web page 150 has images 160, 170a-170f that are in different locations than the image boxes 110, 120a-120f of FIG. 1A. In a budget mode, the images 160, 170a-170f of FIG. 1C may also be replaced with image boxes, which are substantially similar to those described above with respect to FIG. 1A. Referring now to FIG. 1D, the images 160, 170a-170f are replaced with a view finder image as described above with respect to FIG. 1B. In this example, the web page images may be replaced without the web browser being in a budget mode. Here, because the image boxes 160′, 170a′-170f′ are in different locations than the image boxes 110′, 120a′-120f′ a different portion of the view finder image is shown.

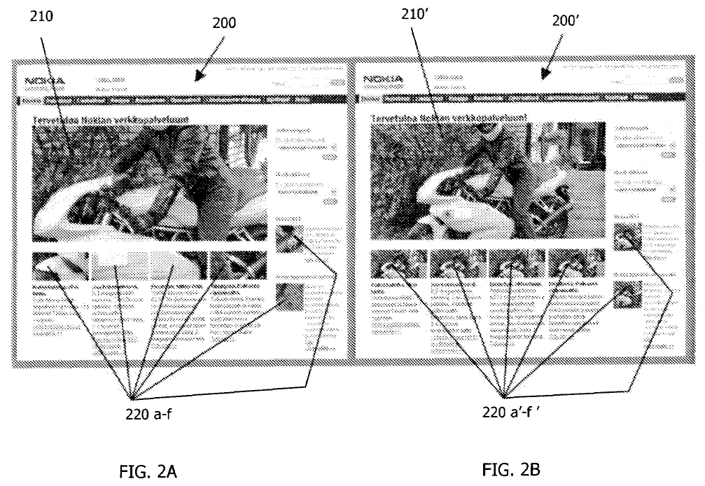

Referring now to FIGS. 2A and 2B, web pages 200, 200′ that are substantially similar to that described above with respect to FIG. 1B are shown. Image boxes 210 and 220a-220f may be substantially similar to the image boxes 110′ and 120a′-120f′. In this example the view finder image is the person on the motorcycle as described above and shown in FIG. 2A.

In accordance with another embodiment, the view finder image may be displayed in each of the image boxes 210′ and 220a′-220f′ as can be seen in FIG. 2B. In this example, the wallpaper or view finder image is resized or cut to fit in a respective one of the image boxes 210′ and 220a′-220f′. As the view finder is pointed in a different direction each of the resized images changes accordingly so that the view finder image is displayed in the image boxes 210′ and 220a′-220f′ in a continually updated fashion. The user may be able to select via, for example, any suitable settings menu whether the view finder image is displayed as shown in either FIG. 2A or FIG. 2B. In alternate embodiments, as the web page is refreshed the view finder image may be displayed in an alternating or random fashion between what is shown in and described above for FIGS. 2A and 2B.

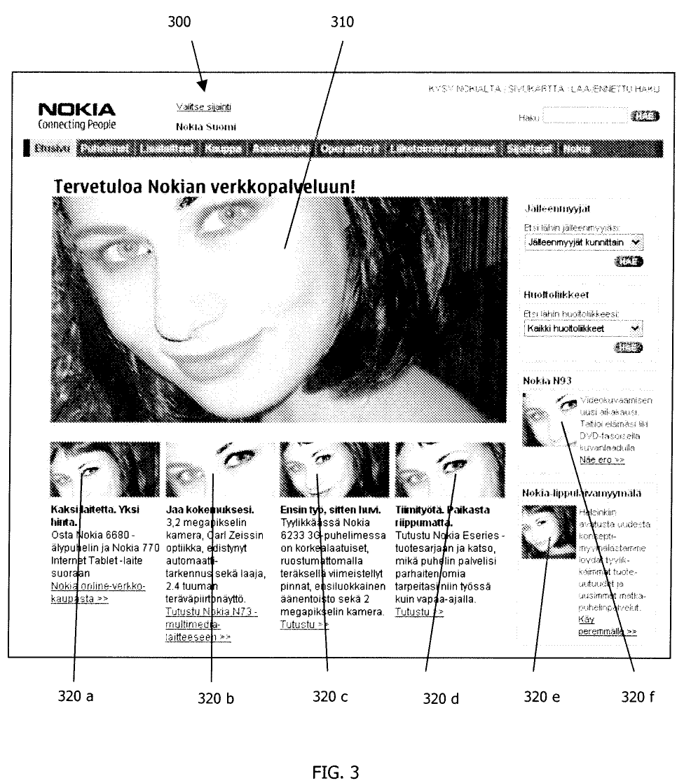

Referring to FIG. 3, in accordance with another embodiment, the view finder images displayed in the image boxes may be presented in various stages of zooming. The web page 300 may be substantially similar to that described above with respect to FIG. 1B. In FIG. 3, the view finder image may any suitable image such as that of the woman shown in the Figure. The image boxes 310, 320a-320f may display the woman in various stages of zooming such as, for example, the woman's head may be shown in image box 320e while the woman's eyes are shown in image box 320b. The various stages of zooming may be user settable in any suitable manner through, for example, any suitable menu and/or setting of the device 800. In alternate embodiments the various stages of zooming may be set during manufacture of the device.

In accordance with another embodiment the images presented in the image boxes may be any suitable images stored within the device 800, such as for example photographs, wallpapers, videos, animations, graphics and the like. In alternate embodiments, the images may be stored on, for example, a memory card or other suitable peripheral device connected to the device 800. The device 800 may be connected to any suitable peripheral device via any suitable connection such as, for example, a wired or wireless connection.

In one embodiment, the image stored in the device may be a single image such as the person on the motorcycle described above. This image may be displayed on the device as a wallpaper or selected by the user from any suitable list of images stored in the device via any suitable settings menu for display as the replacement image for the web browser. The single image may be displayed through the image boxes of the web page in a manner that is substantially similar to that described above with respect to FIG. 1B. The portions of the image visible through the image boxes may be fixed in that as the user scrolls the web page up, down, left or right the portions of the image shown in the image boxes remain the same. In other embodiments the portions of the image visible through the image boxes may be variable in that as the user scrolls the web page up, down, left or right the portions of the image shown in the image boxes “move” to show different portions of the image. In other embodiments, the single image may be resized or cut to fit into each image box as described above with respect to FIG. 2B. In still other embodiments, the single image may be displayed in the image boxes in various stages of zooming as described above with respect to FIG. 3. As described above, the user may select a single image from a list of any suitable images so that the single image is displayed in the image boxes or the user may configure the device so that the image is randomly selected from the list of images. The random image may be selected in any suitable manner such as, for example, the image may be selected depending on a category of images, the context of the image or any other suitable image attribute.

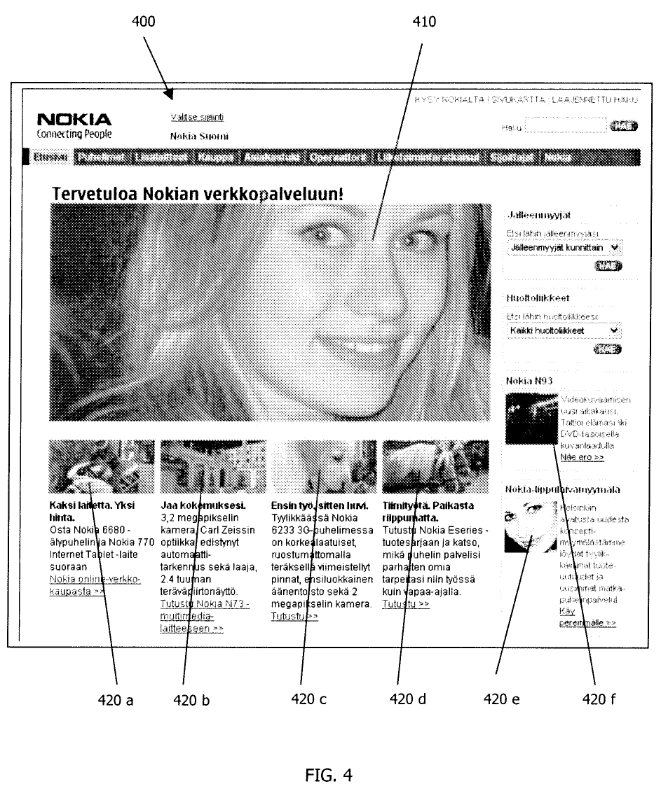

In another embodiment, as can be seen in FIG. 4, the web page 400 may be substantially similar to web page 100′ as described above with respect to FIG. 1B. In this example each of the image boxes 410, 420a-420f displays a different image. The images may be any combination of still images, animations, videos, and the like that are stored in or acquired the device. For example, image box 410 may display the picture of a first woman, image box 420e may display the picture of a second woman, image box 420a may display a picture of a person on a motorcycle and image box 420d may display a video of a horse drawn carriage. The different images for display in each of the image boxes 410, 420a-420f may be selected by a user via any suitable settings menu. In alternate embodiments, the different images for display in each of the images boxes may be randomly selected by the device 800 based on image context or any other image attribute such as, for example, image category.

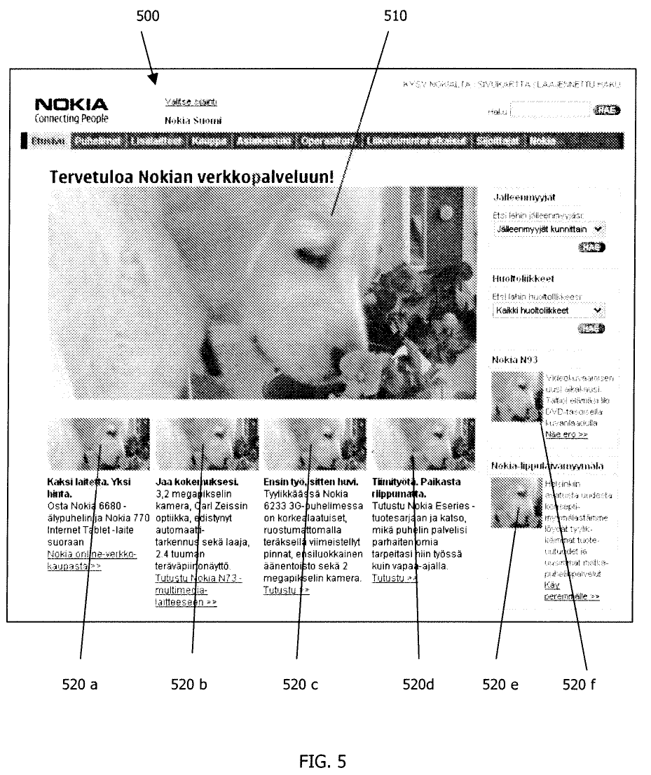

As can be seen in FIG. 5 the web page 500 may be substantially similar to web page 100′ as described above with respect to FIG. 1B. In this example each of the image boxes 510, 520a-520f displays the same image. In this example, an image of a puppy is displayed. The image to be displayed in each of the image boxes 510, 520a-520f may be selected by a user via any suitable settings menu. In alternate embodiments, the image to be displayed in each of the images boxes may be randomly selected by the device 800 based on image context or any other image attribute such as, for example, image category.

In one embodiment, the images to be displayed in the image boxes of FIGS. 4 and 5 may be resized or cut to fit in a respective one of the image boxes. In another embodiment the images may be displayed in various stages of zooming as described above with respect to FIG. 3. In still other embodiments some of the images to be displayed in the image boxes of FIGS. 4 and 5 may be resized or cut to fit a respective one of the image boxes while other images may be displayed in various stages of zooming.

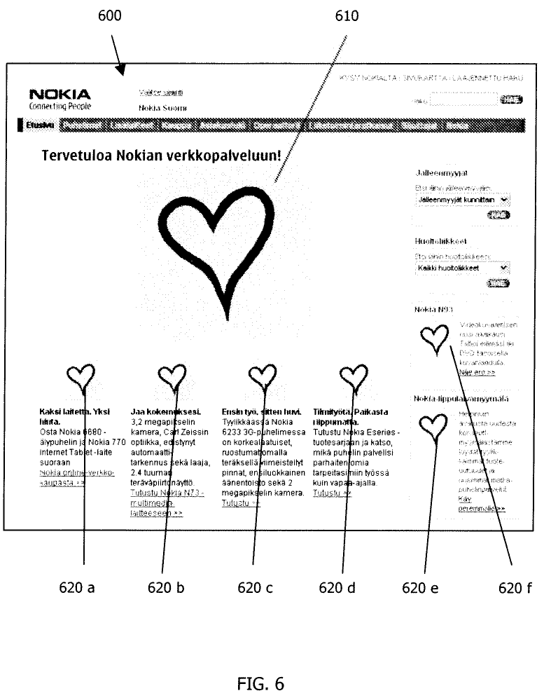

Referring now to FIG. 6, another web page 600 is shown in accordance with an embodiment. Web page 600 may be substantially similar to web page 100′ described above. In this embodiment a two-dimensional graphic is displayed in the text boxes 610, 620a-620f. Here the image is that of a heart but in alternate embodiments any suitable two-dimensional image can be displayed. In other embodiments, any suitable three-dimensional graphic such as, for example, a cube, pyramid, parallelepiped and the like, may be displayed in the image boxes 610, 620a-620f. In alternate embodiments, the graphics presented in the image boxes may be generated by the device 800 via any suitable graphic generating software.

In one embodiment the images displayed in the image boxes described above with may change when the web page is refreshed (FIG. 7, Block 730). For example, image box 510 in FIG. 5 may display the puppy before refreshing the web page 500. After refreshing the web page 500 the image box 510 may display the image of the woman shown in image box 410 of FIG. 4. In other embodiments, the images may not change when the web page is refreshed.

In another embodiment, instead of images being displayed in the image boxes of the web pages, any suitable device application or function may be displayed in the image boxes. For example, one image box may display incoming messages, one image box may display an email function of the device, one image box may display incoming call attributes such as phone numbers or a caller's identification, etc.

In other embodiments, any combination of the images or device functions described above may be displayed in the image boxes of a web page. For example, a view finder image may be displayed in one image box, an email function may be displayed in one image box, a calendar function may be displayed in one image box, a video may be displayed in one image box, etc.

In still other embodiments the images and device functions displayed in the image boxes in the above described embodiments may be modified in any suitable manner (FIG. 7, Block 740). For example, any suitable visual effects may be added to the images such as, for example, animations placed over the image, texturing effects, a blurring effect, a sepia effect, a pixelating effect and the like. These special effects may modify a portion of the image or the entire image. Where there is more than one image box, different visual effects may be randomly applied to each of the image boxes, the same visual effect may be applied to all of the image boxes or the visual effects may be applied to some image boxes while not being applied to other image boxes. The special effects applied to the images may be user selectable via any suitable settings menu.

One embodiment of a device in which the disclosed embodiments may be employed is illustrated in FIG. 2. The device may be any suitable device such as terminal or mobile communications device 800. The terminal 800 may have a keypad 810 and a display 820. The keypad 810 may include any suitable user input devices such as, for example, a multi-function/scroll key 830, soft keys 831, 832, a call key 833 and end call key 834 and alphanumeric keys 835. The display 820 may be any suitable display, such as for example, a touch screen display or graphical user interface. The display may be integral to the device 800 or the display may be a peripheral display connected to the device 800. A pointing device, such as for example, a stylus, pen or simply the user's finger may be used with the display 820. In alternate embodiments any suitable pointing device may be used. In other alternate embodiments, the display may be a conventional display. The device 800 may also include other suitable features such as, for example, a camera, loud speaker, connectivity port or tactile feedback features. The mobile communications device may have a processor 1018 connected to the display for processing user inputs and displaying information on the display 820. A memory 1002 may be connected to the processor 1018 for storing any suitable information and/or applications associated with the mobile communications device 800 such as phone book entries, calendar entries, web browser, etc.

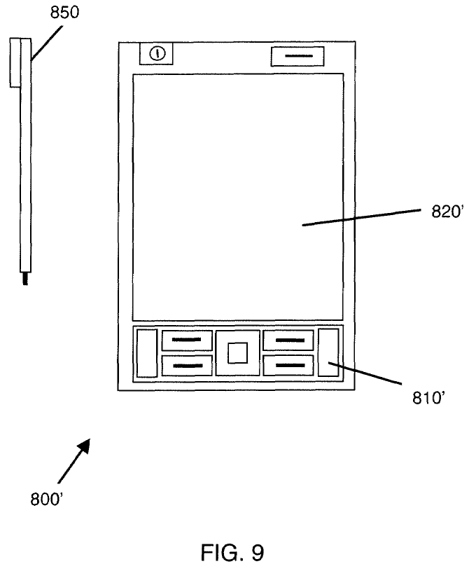

In one embodiment, the device, may be for example, a PDA style device 800′ illustrated in FIG. 9. The PDA 800′ may have a keypad 810′, a touch screen display 820′ and a pointing device 850 for use on the touch screen display 820′. In still other alternate embodiments, the device may be a personal communicator, a tablet computer, a laptop or desktop computer, a television or television set top box or any other suitable device capable of containing the display 820 and supported electronics such as the processor 1018 and memory 1002.

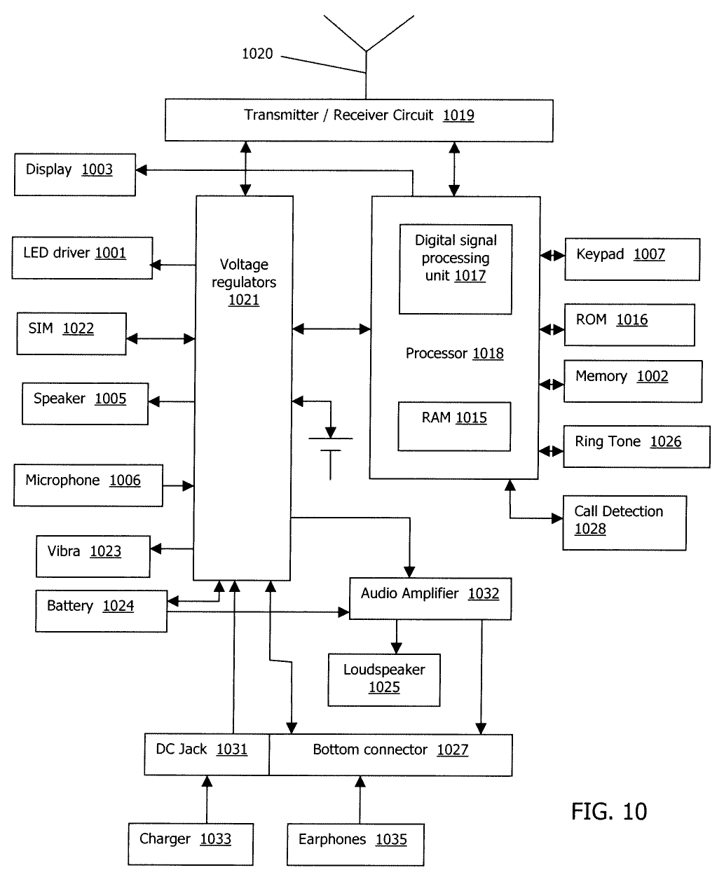

FIG. 10 illustrates in block diagram form one embodiment of a general architecture of the mobile device 200. The mobile communications device may have a processor 1018 connected to the display 1003 for processing user inputs and displaying information on the display 1003. The processor 1018 controls the operation of the device and can have an integrated digital signal processor 1017 and an integrated RAM 1015. The processor 1018 controls the communication with a cellular network via a transmitter/receiver circuit 1019 and an antenna 1020. A microphone 1006 is coupled to the processor 1018 via voltage regulators 1021 that transform the user's speech into analog signals. The analog signals formed are A/D converted in an A/D converter (not shown) before the speech is encoded in the DSP 1017 that is included in the processor 1018. The encoded speech signal is transferred to the processor 1018, which e.g. supports, for example, the GSM terminal software. The digital signal-processing unit 1017 speech-decodes the signal, which is transferred from the processor 1018 to the speaker 1005 via a D/A converter (not shown).

The voltage regulators 1021 form the interface for the speaker 1005, the microphone 1006, the LED drivers 1001 (for the LEDS backlighting the keypad 1007 and the display 1003), the SIM card 1022, battery 1024, the bottom connector 1027, the DC jack 1031 (for connecting to the charger 1033) and the audio amplifier 1032 that drives the (hands-free) loudspeaker 1025.

A processor 1018 can also include memory 1002 for storing any suitable information and/or applications associated with the mobile communications device 200 such as phone book entries, calendar entries, etc.

The processor 1018 also forms the interface for peripheral units of the device, such as for example, a (Flash) ROM memory 1016, the graphical display 1003, the keypad 1007, a ringing tone selection unit 1026, and an incoming call detection unit 1028. In alternate embodiments, any suitable peripheral units for the device can be included.

The software in the RAM 1015 and/or in the flash ROM 1016 contains instructions for the processor 1018 to perform a plurality of different applications and functions such as, for example, those described herein.

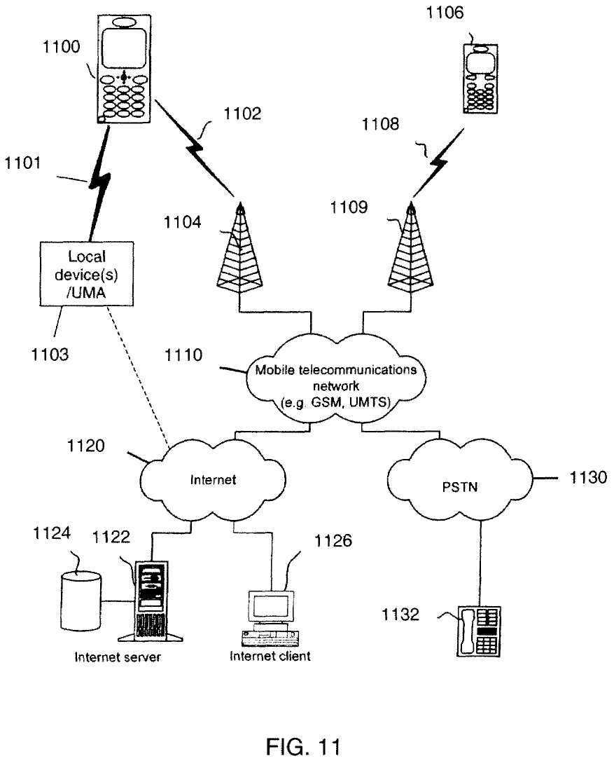

FIG. 11 is a schematic illustration of a cellular telecommunications system, as an example, of an environment in which a communications device 1100 incorporating features of an embodiment may be applied. Communication device 1100 may be substantially similar to that described above with respect to terminals 200. In the telecommunication system of FIG. 11, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 1100 and other devices, such as another mobile terminal 1106, a stationary telephone 1132, or an internet server 1122. It is to be noted that for different embodiments of the mobile terminal 1100 and in different situations, different ones of the telecommunications services referred to above may or may not be available. The aspects of the invention are not limited to any particular set of services in this respect.

The mobile terminals 1100, 1106 may be connected to a mobile telecommunications network 1110 through radio frequency (RF) links 1102, 1108 via base stations 1104, 1109. The mobile telecommunications network 1110 may be in compliance with any commercially available mobile telecommunications standard such as GSM, UMTS, D-AMPS, CDMA2000, FOMA and TD-SCDMA.

The mobile telecommunications network 1110 may be operatively connected to a wide area network 1120, which may be the internet or a part thereof. An internet server 1122 has data storage 1124 and is connected to the wide area network 1120, as is an internet client computer 1126. The server 1122 may host a www/hap server capable of serving www/hap content to the mobile terminal 1100.

For example, a public switched telephone network (PSTN) 1130 may be connected to the mobile telecommunications network 1110 in a familiar manner. Various telephone terminals, including the stationary telephone 1132, may be connected to the PSTN 1130.

The mobile terminal 1100 is also capable of communicating locally via a local link 1101 to one or more local devices 1103. The local link 1101 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 1103 can, for example, be various sensors that can communicate measurement values to the mobile terminal 1100 over the local link 1101. The above examples are not intended to be limiting, and any suitable type of link may be utilized. The local devices 1103 may be antennas and supporting equipment forming a WLAN implementing Worldwide Interoperability for Microwave Access (WIMAX, IEEE 802.16), WiFi (IEEE 802.11x) or other communication protocols. The WLAN may be connected to the internet. The mobile terminal 1100 may thus have multi-radio capability for connecting wirelessly using mobile communications network 1110, WLAN or both. Communication with the mobile telecommunications network 1110 may also be implemented using WiFi, WiMax, or any other suitable protocols, and such communication may utilize unlicensed portions of the radio spectrum (e.g. unlicensed mobile access (UMA)).

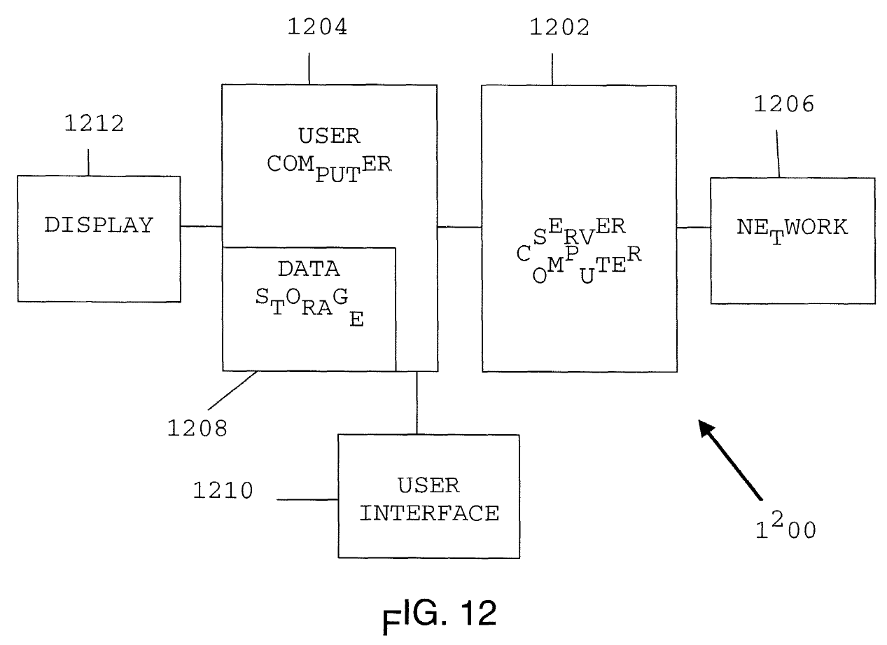

The disclosed embodiments may also include software and computer programs incorporating the process steps and instructions described herein that are executed in different computers. FIG. 12 is a block diagram of one embodiment of a typical apparatus 1200 incorporating features that may be used to practice aspects of the embodiments. As shown, a computer system 1202 may be linked to another computer system 1204, such that the computers 1202 and 1204 are capable of sending information to each other and receiving information from each other. In one embodiment, computer system 1202 could include a server computer adapted to communicate with a network 1206. Computer systems 1202 and 1204 can be linked together in any conventional manner including, for example, a modem, hard wire connection, or fiber optic link. Generally, information can be made available to both computer systems 1202 and 1204 using a communication protocol typically sent over a communication channel or through a dial-up connection on ISDN line. Computers 1202 and 1204 are generally adapted to utilize program storage devices embodying machine readable program source code which is adapted to cause the computers 1202 and 1204 to perform the method steps disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 1202 and 1204 may also include a microprocessor for executing stored programs. Computer 1202 may include a data storage device 1208 on its program storage device for the storage of information and data. The computer program or software incorporating the processes and method steps incorporating aspects of the invention may be stored in one or more computers 1202 and 1204 on an otherwise conventional program storage device. In one embodiment, computers 1202 and 1204 may include a user interface 1210, and a display interface 1212 from which aspects of the invention can be accessed. The user interface 1210 and the display interface 1212 can be adapted to allow the input of queries and commands to the system, as well as present the results of the commands and queries.

The embodiments described above, allows for the personalization of a document while saving a user money for internet connection time, decreasing document download times and saving device power. The above described embodiments also allow a user to view image content of the device while surfing the internet, “see through” the device via displaying a view finder image in one or more image boxes and view multiple device functions while surfing the internet. The above described embodiments may also provide entertainment to the user of the device as the captions for the document images will be describing the user's personalized images rather than the images associated with the document content.

It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. An apparatus comprising:
a display; and
a processor connected to the display, wherein the processor is configured to replace at least one image in at least one image box of a document presented on the display with at least one different image from the apparatus.

2. The apparatus of claim 1, wherein the at least one different image is an image stored in a memory of the apparatus or an image acquired by the apparatus.

3. The apparatus of claim 1, wherein the at least one different image comprises one or more of a view finder image, a background image, a wallpaper image, a photograph, a graphical image, an animated image, a video, or a visualization generated the processor.

4. The apparatus of claim 1, wherein the processor is configured to present the at least one different image in place of the at least one image in the at least one image box so that portions of the at least one different image are displayed through a respective one of the at least one image box.

5. The apparatus of claim 4, wherein the processor is configured to present a different portion of the at least one different image depending on a scroll position of a web page.

6. The apparatus of claim 4, wherein the processor is configured to present a different portion of the at least one different image depending on a direction that a view finder of the apparatus is pointing.

7. The apparatus of claim 1, wherein the apparatus is a mobile communication device.

8. The apparatus of claim 1, wherein the processor is configured to present the at least one different image in the at least one image box in various stages of zooming.

9. The apparatus of claim 1, wherein the processor is configured to scale or cut the at least one different image so the at least one different image fits inside a respective one of the at least one image box.

10. The apparatus of claim 1, wherein the processor is configured to present at least one application of the apparatus in the at least one image box.

11. A method comprising:
downloading a document for presentation on a device; and
replacing at least one image in at least one image box of the document with at least one different image from the device.

12. The method of claim 11, wherein the at least one image in the at least one image box is replaced with at least one image stored in a memory of the device or an image acquired by the device.

13. The method of claim 11, wherein the at least one different image comprises one or more of a view finder image, a background image, a wallpaper image, a photograph, a graphical image, an animated image, a video, or a visualization generated the processor.

14. The method of claim 11, further comprising presenting the at least one different image in place of the at least one image in the at least one image box so that portions of the at least one different image are displayed through a respective one of the at least one image box.

15. The method of claim 14, further comprising presenting a different portion of the at least one different image depending on a scroll position of a web page.

16. The method of claim 14, further comprising presenting a different portion of the at least one different image depending on a direction that a view finder of the device is pointing.

17. The method of claim 11, further comprising presenting the at least one different image in the at least one image box in various stages of zooming.

18. The method of claim 11, further comprising scaling or cutting the at least one different image so the at least one different image fits inside a respective one of the at least one image box.

19. The method of claim 1, further comprising presenting at least one application of the device in the at least one image box.

20. A computer program product comprising:
a computer useable medium having computer readable code means embodied therein for causing a computer replace at least one image in at least one image box of a document with at least one different image, the computer readable code means in the computer program product comprising:
computer readable program code means for causing a computer to download the document for presentation on a device; and
computer readable program code means for causing a computer to replace at least one image in at least one image box of the document with at least one different image from the device.
